(19) United States
(12) Patent Application Publication
(10) Pub. No.: US 2023/0397116 A1
(43) Pub. Date: Dec. 7, 2023

(54) CONFIGURATION OF WAKE UP SIGNAL FOR NEW RADIO WIRELESS DEVICE PAGING

(71) Applicant: Telefonaktiebolaget LM Ericsson (publ), Stockholm (SE)

(72) Inventors: Sina MALEKI, Malmö (SE); Andres REIAL, Höllviken (SE); Ajit NIMBALKER, Dublin, CA (US); Ravikiran NORY, San José, CA (US)

(21) Appl. No.: 18/248,994

(22) PCT Filed: Oct. 18, 2021
(86) PCT No.: PCT/EP2021/078736

§ 371 Date: Apr. 13, 2023

Related U.S. Application Data
(60) Provisional application No. 63/092,706, filed on Oct. 16, 2020.

(51) Int. Cl. H04W 52/02; H04W 68/02; H04W 72/232

(52) U.S. Cl. CPC H04W 52/0235; H04W 72/232; H04W 52/0216; H04W 68/02

(57) ABSTRACT

A method, system and apparatus for configuring a wakeup signal for New Radio (NR) wireless device (WD) paging are disclosed. According to one aspect, a method in a WD includes receiving a paging wake up signal (PWUS) associated with a radio network temporary identifier (RNTI), the PWUS including an indication of at least one paging occasion (PO), to be one of monitored and not monitored, and one of monitoring and not monitoring at least one of the at least one PO as indicated by the PWUS.

### FIELD

The present disclosure relates to wireless communications, and in particular, to configuring a wakeup signal for New Radio (NR) wireless device (WD) paging.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), such as user equipment (UE), as well as communication between network nodes and between WDs. Sixth Generation (6G) wireless communication systems are also under development.

Wireless communication systems according to the 3GPP may include one or more of the following channels:
A physical downlink control channel, PDCCH;
A physical uplink control channel, PUCCH;
A physical downlink shared channel, PDSCH;
A physical uplink shared channel, PUSCH;
A physical broadcast channel, PBCH; and
A physical random access channel, PRACH.

Idle DRX and WUS

Idle/inactive discontinuous reception (DRX) is an energy saving mechanism allowing the WD to remain in deep sleep most of the time when no data transmission is ongoing. DRX operation by a WD entails paging monitoring and radio resource management (RRM) measurements to determine the appropriate camping cell. The network (NW), such as via a network node, configures the WD with a DRX period that determines the paging monitoring rate. Typically, RRM measurements are performed at the same rate.

For LTE machine type communications (mMTC) and narrow band Internet of things (NB-IoT) devices for which DRX activities are a dominant source of energy consumption, a wake-up signal (WUS) solution for idle mode was specified in 3GPP Technical Release 15 (3GPP Rel-15). The approach defined a sequence-based signal design and addressed primarily the use case associated with physical downlink control channel (PDCCH) coverage extension, i.e., paging PDCCH repetition in a paging occasion (PO). The approach may be referred to as mMTC-WUS.

Connected DRX and WUS

In the connected mode, the cDRX framework can be used to reduce unnecessary monitoring of scheduling PDCCH messages, when no new data is available for transmission in layer 1 (L1). WUS for cDRX has been specified in 3GPP Release 16, using a PDCCH-based WUS design. It may be referred to as connected mode-WUS.

SSB Transmission

In NR deployments, a cell is identified using one or more (up to 64 in FR2) SSB beams. A synchronization signal block (SSB) occupies 20 resource blocks (RBs) and includes 3 components: a primary synchronization signal (PSS) for coarse synchronization and cell group identification, a secondary synchronization signal (SSS) for cell identification, and a physical broadcast channel (PBCH) for primary system information (SI) delivery (via a master information block (MIB)). The PSS and the SSS are sequence-based while the PBCH is encoded and includes demodulation reference signals (DMRS) for channel estimation to enable decoding.

FIG. 1 is a diagram of example frequency resource assignments. FIG. 2 is a diagram of example temporal resources and symbols. FIG. 3 is a diagram of a distribution in time of multiple SSB beams.

SS block time locations are indexed from 0 to L-1 in increasing order within a half radio frame:
L=4:
   SS block time indices are indicated by the 2 least significant bits (LSB) of the 3 bits indicating 8 different PBCH-DMRS sequences (the most significant bit (MSB) is used for half-frame index);
L=8:
   a) SS block time indices are indicated by 8 different PBCH-DMRS sequences;
L=64:
   LSBs of a SS block time index are indicated by 8 different PBCH-DMRS sequences;
   MSBs of a SS block time index are indicated in NR-PBCH payload; and
   3 bits in the NR-PBCH payload in below 6 GHz case may be used for other purpose(s).

Joint usage of NR-PBCH DMRS sequences and explicit bits (L=64 case) in NR-PBCH payload to indicate SS block time index follows the following principles:
1. MSB bits (b5, . . . , b3) for SS block time index in NR-PBCH payload only in case of above 6 GHz;
2. These 3 bits below 6 GHz case are used for other purposes (2 reserved bits and 1 MSB bit for SSB-subcarrier-offset); and
3. 2 or 3 LSB bits of SSB index are indicated by 4 or 8 DMRS sequences.

FIG. 4 shows an example, using a 120 kHZ subcarrier spacing (SCS), of the indication of SSB time index from 0 to 63. Note that each smallest shaded box is or corresponds to a slot, each of which includes 2 SSBs, and 8 DM-RS sequences maps to 4 boxes. The shaded boxes in FIG. 4 may represent an alternating sequence of slots.

In the 3GPP Technical Release 17 work item (WI) on WD power savings, the desirability of developing an early paging indication or a wake-up signal (WUS) for paging has been considered, but the detailed mechanisms have not been decided by the 3GPP.

### SUMMARY

Some embodiments advantageously provide methods, systems, and apparatuses for configuring a wakeup signal for New Radio (NR) wireless device (WD) paging.

Some embodiments include several mechanisms with which the NR WD can be configured with WUS for paging (from here on PWUS) and its underlying parameters. Herein, it is assumed that the PWUS is included in a downlink control information (DCI) signal associated with a specific radio network temporary identifier (RNTI). Among others, detailed configuration of the following parameters are disclosed:
PWUS DCI format, SS/coreset, and RNTI;
PWUS offset, range and mobile originated (MO) configuration;
PWUS association with one or more POs and/or paging groups;
PWUS DCI contents and interpretation; and
PWUS configuration information provision.

The PWUS configuration for a NR WD can help the WD to shorten the average wake-up time before a PO and thereby achieve power savings.

According to one aspect, a network node is configured to communicate with a wireless device, WD. The network node includes processing circuitry configured to configure a paging wake up signal, PWUS, the PWUS being associated with a radio network temporary identifier, RNTI, and including an indication of at least one paging occasion, PO, to be one of monitored and not monitored by the WD. The network node also includes a radio interface in communication with the processing circuitry and configured to transmit the PWUS to the WD.

According to this aspect, in some embodiments, the RNTI to which the PWUS is associated depends on a format of downlink control information, DCI, configured to carry the PWUS transmitted by the radio interface. In some embodiments, the RNTI to which the PWUS is associated is a P-RNTI when the DCI format is 1-0. In some embodiments, the PWUS is configured to wake up the WD from one of an idle mode and an inactive mode. In some embodiments, the processing circuitry is further configured to configure the WD to monitor the PWUS according to a selected one of a plurality of search space configurations. In some embodiments, the PWUS is associated with a plurality of POs. In some embodiments, each of the at least one PO is selected to be one of monitored and not monitored based on a formula. In some embodiments, the PWUS is included in a downlink control information, DCI, message on a physical downlink control channel, PDCCH. In some embodiments, the DCI message includes PO usage information. In some embodiments, a DCI message size of zero indicates that an upcoming PO is to be one of monitored and not monitored. In some embodiments, whether the DCI message size of zero indicates that the upcoming PO is to be one of monitored and not monitored is pre-configured by the network node. In some embodiments, the processing circuitry is further configured to multiplex the DCI message with other DCI messages based on a network load. In some embodiments, the PWUS further indicates which of a plurality of upcoming POs have a paging message. In some embodiments, the PWUS is configured by the network node to indicate a PO to be one of monitored and not monitored based on a frequency of paging. In some embodiments, the PWUS is configured to be valid for a finite duration of time.

According to another aspect, a method in a network node configured to communicate with a wireless device, WD, is provided. The method includes configuring a paging wake up signal, PWUS, the PWUS being associated with a radio network temporary identifier, RNTI, and including an indication of at least one paging occasion, PO, to be one of monitored and not monitored by the WD. The method also includes transmitting the PWUS to the WD.

According to this aspect, in some embodiments, the RNTI to which the PWUS is associated depends on a format of downlink control information, DCI, configured to carry the PWUS transmitted by the radio interface. In some embodiments, the RNTI to which the PWUS is associated is a P-RNTI when the DCI format is 1-0. In some embodiments, the PWUS is configured to wake up the WD from one of an idle mode and an inactive mode. In some embodiments, the method also includes configuring the WD to monitor the PWUS according to a selected one of a plurality of search space configurations. In some embodiments, the PWUS is associated with a plurality of POs. In some embodiments, each of the at least one PO is selected to be one of monitored and not monitored based on a formula. In some embodiments, the PWUS is included in a downlink control information, DCI, message on a physical downlink control channel, PDCCH. In some embodiments, the DCI message include PO usage information. In some embodiments, a DCI message size of zero indicates that an upcoming PO is to be one of monitored and not monitored. In some embodiments, whether the DCI message size of zero indicates that the upcoming PO is to be one of monitored and not monitored is configured by the network node. In some embodiments, the processing circuitry is further configured to multiplex the DCI message with other DCI messages based on a network load. In some embodiments, the PWUS further indicates which of a plurality of upcoming POs have a paging message. In some embodiments, the PWUS is configured by the network node to indicate a PO to be one of monitored and not monitored based on a frequency of paging. In some embodiments, the PWUS is configured to be valid for a finite duration of time.

According to yet another aspect, a WD configured to communicate with a network node is provided. The WD includes a radio interface configured to receive a paging wake up signal, PWUS, associated with a radio network temporary identifier, RNTI, the PWUS including an indication of at least one paging occasion, PO, to be one of monitored and not monitored. The WD also includes processing circuitry in communication with the radio interface and configured to one of monitor and not monitor at least one of the at least one PO as indicated by the PWUS.

According to this aspect, in some embodiments, the RNTI to which the PWUS is associated depends on a format of downlink control information, DCI, configured to carry the PWUS. In some embodiments, the RNTI to which the PWUS is associated is a P-RNTI. In some embodiments, the RNTI to which the PWUS is associated is a ps-RNTI. In some embodiments, the RNTI to which the PWUS is associated is a paging power saving RNTI. In some embodiments, the PWUS is configured to wake up the WD from one of an idle mode and an inactive mode. In some embodiments, the processing circuitry is further configured to monitor a PWUS according to a selected one of a plurality of search space configurations.

According to another aspect, a method in a WD configured to communicate with a network node is provided. The method includes receiving a paging wake up signal, PWUS, associated with a radio network temporary identifier, RNTI, the PWUS including an indication of at least one paging occasion, PO, to be one of monitored and not monitored. The method also includes one of monitoring and not monitoring at least one of the at least one PO as indicated by the PWUS.

According to this aspect, in some embodiments, the RNTI to which the PWUS is associated depends on a format of downlink control information, DCI, configured to carry the PWUS. In some embodiments, the RNTI to which the PWUS is associated is a P-RNTI. In some embodiments, the RNTI to which the PWUS is associated is a ps-RNTI. In some embodiments, the RNTI to which the PWUS is associated is a paging power saving RNTI. In some embodiments, the PWUS is configured to wake up the WD from one of an idle mode and an inactive mode. In some embodiments, the method also includes monitoring a PWUS according to a selected one of a plurality of search space configurations.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a diagram of frequency resource assignments;

FIG. 2 is a diagram of temporal resources and symbols;

FIG. 3 is a diagram of a distribution in time of multiple SSB beams;

FIG. 4 is an illustration showing the indication of SSB time index from 0 to 63;

FIG. 5 is a schematic diagram of an example network architecture illustrating a communication system connected via an intermediate network to a host computer according to the principles in the present disclosure;

FIG. 6 is a block diagram of a host computer communicating via a network node with a wireless device over an at least partially wireless connection according to some embodiments of the present disclosure;

FIG. 7 is a flowchart illustrating example methods implemented in a communication system including a host computer, a network node and a wireless device for executing a client application at a wireless device according to some embodiments of the present disclosure;

FIG. 8 is a flowchart illustrating example methods implemented in a communication system including a host computer, a network node and a wireless device for receiving user data at a wireless device according to some embodiments of the present disclosure;

FIG. 9 is a flowchart illustrating example methods implemented in a communication system including a host computer, a network node and a wireless device for receiving user data from the wireless device at a host computer according to some embodiments of the present disclosure;

FIG. 10 is a flowchart illustrating example methods implemented in a communication system including a host computer, a network node and a wireless device for receiving user data at a host computer according to some embodiments of the present disclosure;

FIG. 11 is a flowchart of an example process in a network node for configuring a wakeup signal for New Radio (NR) wireless device (WD) paging;

FIG. 12 is a flowchart of an example process in a wireless device for configuring a wakeup signal for New Radio (NR) wireless device (WD) paging;

FIG. 13 is a flowchart of another example process in a network node according to some embodiments of the present disclosure;

FIG. 14 is a flowchart of another example process in a wireless device according to some embodiments of the present disclosure; and

FIG. 15 is an example of PWUS detection timing.

### DETAILED DESCRIPTION

Before describing in detail example embodiments, it is noted that the embodiments reside primarily in combinations of apparatus components and processing steps related to configuring a wakeup signal for New Radio (NR) wireless device (WD) paging. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide for configuring a wakeup signal for New Radio (NR) wireless device (WD) paging. According to one aspect, a method in a WD includes waking up upon receiving a paging wake up signal (PWUS) and monitoring for a paging message when an indication in the received PWUS indicates an upcoming paging opportunity (PO). The PWUS provides an early indication of an upcoming PO and is a paging early indicator.

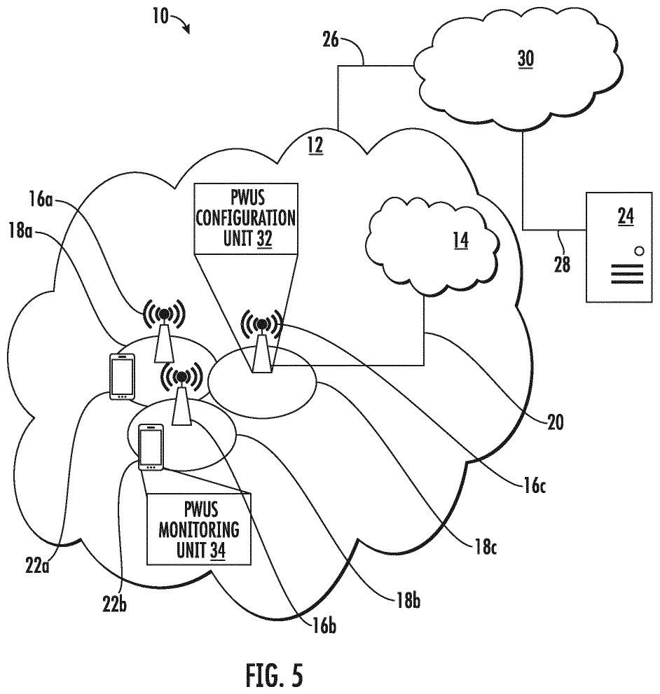

Referring again to the drawing figures, in which like elements are referred to by like reference numerals, there is shown in FIG. 5 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

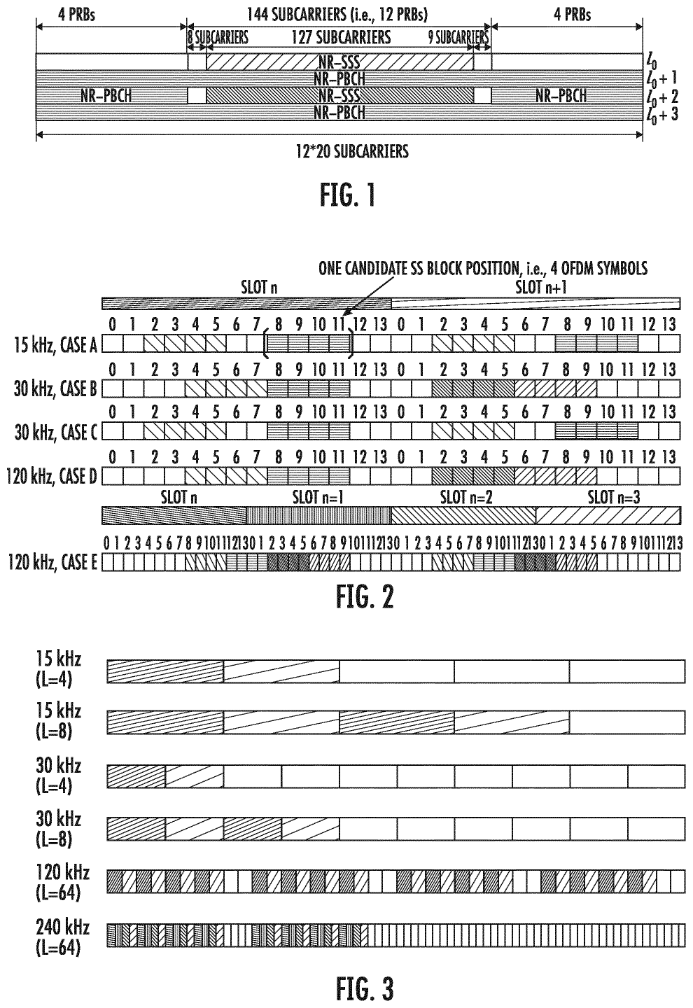

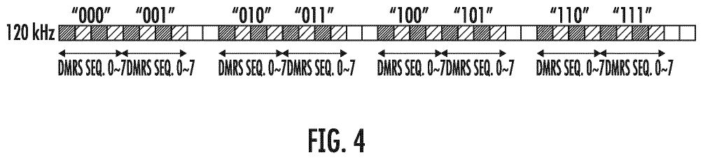

The communication system of FIG. 1 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a PWUS configuration unit 32 which is configured to configure a paging wake up signal, PWUS, the PWUS being associated with a radio network temporary identifier, RNTI, and including an indication of at least one paging occasion, PO, to be one of monitored and not monitored by the WD 22. The WD is configured to include a PWUS monitoring unit 34 that is configured to monitor or not monitor at least one of the at least one PO as indicated by the PWUS.

Example implementations, in accordance with an embodiment, of the WD 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include a PWUS configuration unit 32 which is configured to configure a paging wake up signal, PWUS, the PWUS being associated with a radio network temporary identifier, RNTI, and including an indication of at least one paging occasion, PO, to be one of monitored and not monitored by the WD.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a PWUS monitoring unit 34 that is configured to monitor or not monitor at least one of the at least one PO as indicated by the PWUS.

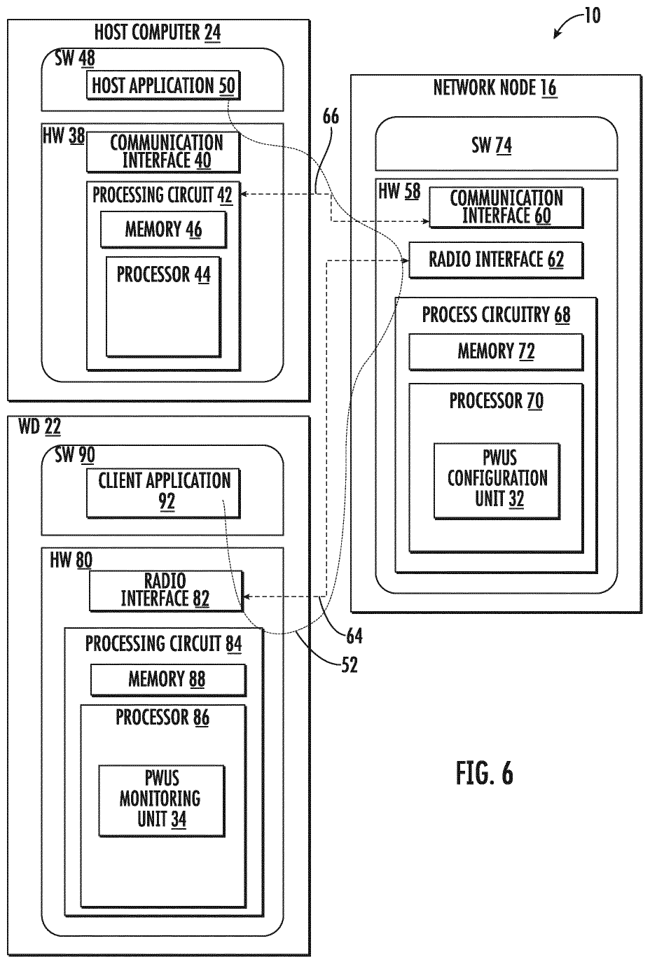

In some embodiments, the inner workings of the network node 16, WD 22, and host computer 24 may be as shown in FIG. 6 and independently, the surrounding network topology may be that of FIG. 5.

In FIG. 6, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 5 and 6 show various “units” such as PWUS configuration unit 32, and PWUS monitoring unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

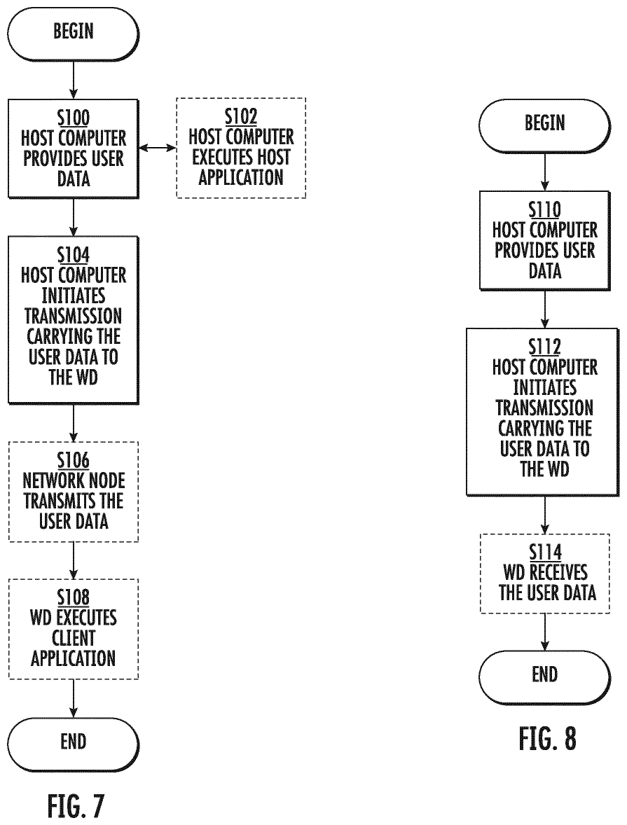

FIG. 7 is a flowchart illustrating an example method implemented in a communication system, such as, for example, the communication system of FIGS. 5 and 6, in accordance with one embodiment. The communication system may include a host computer 24, a network node 16 and a WD 22, which may be those described with reference to FIG. 6. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 8 is a flowchart illustrating an example method implemented in a communication system, such as, for example, the communication system of FIG. 5, in accordance with one embodiment. The communication system may include a host computer 24, a network node 16 and a WD 22, which may be those described with reference to FIGS. 5 and 6. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

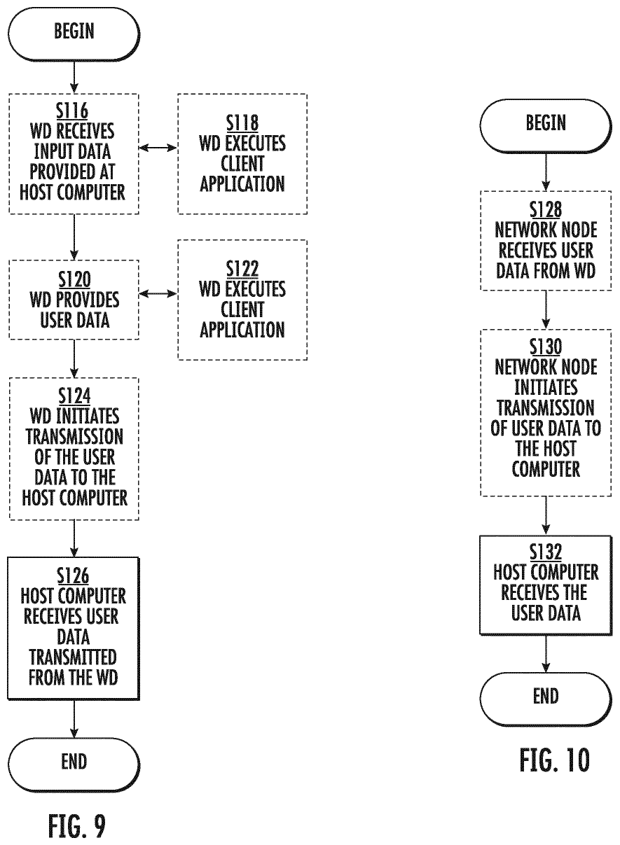

FIG. 9 is a flowchart illustrating an example method implemented in a communication system, such as, for example, the communication system of FIG. 5, in accordance with one embodiment. The communication system may include a host computer 24, a network node 16 and a WD 22, which may be those described with reference to FIGS. 5 and 6. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 10 is a flowchart illustrating an example method implemented in a communication system, such as, for example, the communication system of FIG. 5, in accordance with one embodiment. The communication system may include a host computer 24, a network node 16 and a WD 22, which may be those described with reference to FIGS. 5 and 6. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

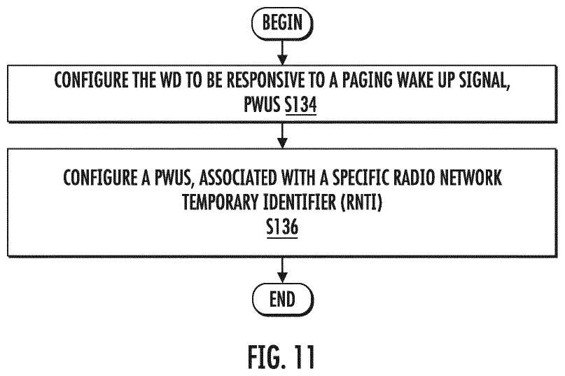

FIG. 11 is a flowchart of an example process in a network node 16 for configuring a wakeup signal for New Radio (NR) wireless device (WD) paging. One or more blocks described herein may be performed by one or more elements of network node 16 such as by one or more of processing circuitry 68 (including the PWUS configuration unit 32), processor radio interface 62 and/or communication interface 60. Network node 16 such as via processing circuitry 68 and/or processor 70 and/or radio interface 62 and/or communication interface 60 is configured to configure the WD to be responsive to a paging wake up signal, PWUS (Block S134). The process also includes configuring a PWUS, associated with a specific radio network temporary identifier (RNTI) (Block S136).

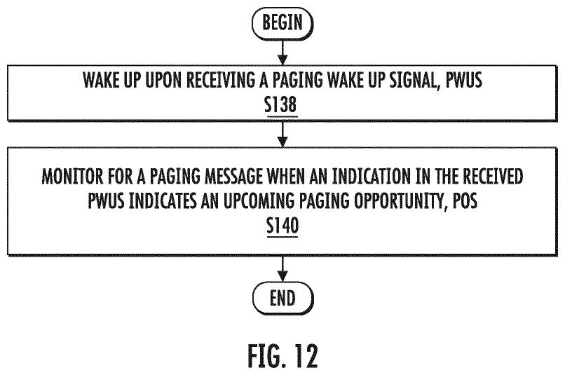

FIG. 12 is a flowchart of an example process in a wireless device 22 according to some embodiments of the present disclosure. One or more blocks described herein may be performed by one or more elements of wireless device 22 such as by one or more of processing circuitry 84 (including the PWUS monitoring unit 34), processor 86, radio interface 82 and/or communication interface 60. Wireless device 22, such as via processing circuitry 84 and/or processor 86 and/or radio interface 82, is configured to wake up upon receiving a paging wake up signal, PWUS (Block S138). The process also includes monitoring for a paging message when an indication in the received PWUS indicates an upcoming paging opportunity, PO (Block S140).

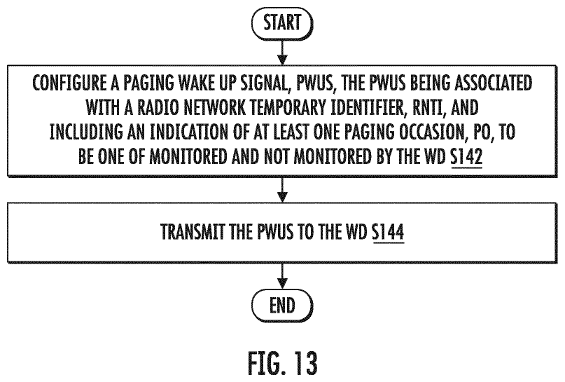

FIG. 13 is a flowchart of an example process in a network node 16 for configuring a wakeup signal for New Radio (NR) wireless device (WD) paging. One or more blocks described herein may be performed by one or more elements of network node 16 such as by one or more of processing circuitry 68 (including the PWUS configuration unit 32), processor 70, radio interface 62 and/or communication interface 60. Network node 16 such as via processing circuitry 68 and/or processor 70 and/or radio interface 62 and/or communication interface 60 is configured to configure a paging wake up signa, PWUS, the PWUS being associated with a radio network temporary identifier, RNTI, and including an indication of at least one paging occasion, PO, to be one of monitored and not monitored by the WD (Block S142). The process also includes transmitting the PWUS to the WD (Block S144).

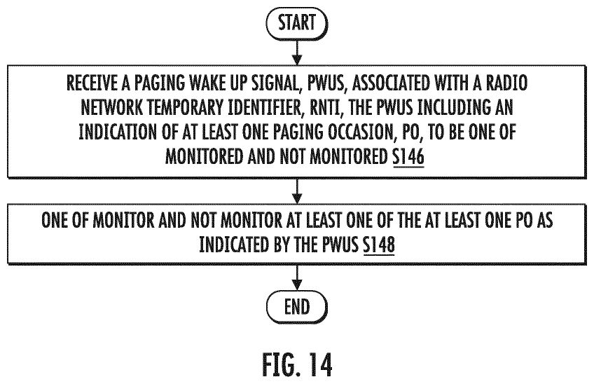

FIG. 14 is a flowchart of an example process in a wireless device 22 according to some embodiments of the present disclosure. One or more blocks described herein may be performed by one or more elements of wireless device 22 such as by one or more of processing circuitry 84 (including the PWUS monitoring unit 34), processor 86, radio interface 82 and/or communication interface 60. Wireless device 22, such as via processing circuitry 84 and/or processor 86 and/or radio interface 82, is configured to receive a paging wake up signal, PWUS, associated with a radio network temporary identifier, RNTI, the PWUS including an indication of at least one paging occasion, PO, to be one of monitored and not monitored (Block S146). The process also includes one of monitoring and not monitoring at least one of the at least one PO as indicated by the PWUS (Block S148).

In the 3GPP Technical Release 17 work item (WI) on WD power savings, the desirability of developing an early paging indication or a wake-up signal (WUS) for paging has been considered. One idea is to send an indication to the WD before a paging message, such that the WD knows whether to monitor its paging occasions (PO). When the WD does not have to monitor its PO (i.e., the WD is not expected to be paged), then the WD can go back to sleep and skip monitoring its PO as well as early wake-up for synchronization purposes, thereby potentially achieving power savings.

While the idea of WUS for paging has been considered at a high level, the detailed mechanisms have not been decided by the 3GPP. For example, how the WUS should be configured and what should be the medium for communicating the configuration have not been decided by the 3GPP.

Having described the general process flow of arrangements of the disclosure and having provided examples of hardware and software arrangements for implementing the processes and functions of the disclosure, the sections below provide details and examples of arrangements for configuring a wakeup signal for New Radio (NR) wireless device (WD) paging.

A purpose of transmitting a PWUS is to provide an advanced notification with a specific offset to one or more POs that an upcoming PO will contain a paging indication and paging message to one or more WDs 22 monitoring the PWUS. When a PWUS is configured but no PWUS is detected, in one example, the WD 22 can skip monitoring paging in the corresponding paging occasions. For example, the WD 22 may omit the light sleep segment after SSB measurement and sync update. The WD 22 may also omit PDCCH sample collection and processing, and instead return to deep sleep immediately.

If the paging rate in the PO is low and few POs are occupied, then a separate WUS monitoring action in addition to the paging PDCCH monitoring may be expected to have a low overhead. The separate WUS monitoring action may also provide an advantageous trade-off for the WD 22 since many paging PDCCH monitoring occasions can be skipped.—Omitting the actions listed above provide a PS gain that is not compromised by additional PWUS reception.

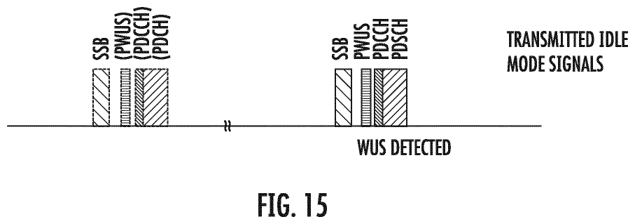

However, when the WD 22 is frequently alerted by a WUS to perform PO monitoring, the additional power and energy expense due to additional PWUS monitoring may become an overhead that is not justified. FIG. 15 illustrates an example of PWUS detection timing.

The PWUS can be designed in different ways, e.g., a PDCCH or DCI based WUS, or a sequence based WUS, or a WUS based on a reference signal. In some embodiments, the PWUS is considered to be DCI based, arriving with a specific offset to one or more POs, and can potentially include indication to skip or monitor the underlying PO. As such, some embodiments include mechanisms with which the WD 22 can be configured with the underlying parameters of a DCI based PWUS.

PWUS DCI Format and RNTI

In one embodiment, the PWUS may be a PDCCH-based DCI, e.g., using DCI format 2-6 for idle WDs 22. In some embodiments, the PWUS may be in a new DCI format. The underlying DCI format can be based on the existing DCIs, e.g., DCI format 1-0 used for paging DCI, or can be based on PS DCIs or can be based on DCI format 2-6, or a new DCI format. For example, DCI format 2-x may be specifically designed for PWUS.

In cases where existing DCIs, such as DCI format 1-0, are used, the PWUS content can be included with the reserved bits, either together with another paging DCI message, such as in the reserved bits of an earlier paging DCI in an earlier PO, or a standalone DCI format 1-0 for PWUS. In this case, in one example, the reserved index in the short message indicator of the paging DCI format 1-0 can be used to indicate that the DCI format 1-0 is for PWUS. In another example, the specific configuration may indicate the DCI is intended for PWUS, e.g., a specific SS/Coreset association, or a specific time/frequency (T/F) location or a PWUS. In this case, the DCI format 1-0 can be simplified further to reduce the DCI payload size, e.g., a short message indicator, T/F allocation, etc.

If DCI format 2-6 is used, the DCI content field can be simplified, e.g., the fields related to secondary cell (Scell) dormancy indication can be removed, but the wake-up indication fields can be kept. Each of the wake-up indication fields can be associated with one or more WDs 22, or one or more POs. Alternatively, a new DCI format can be developed for PWUS, e.g., DCI format 2-x. As such, the higher layer signaling can be used to configure the WD 22 with the specific underlying parameters, which may include: the DCI size, RNTI, offset, content and bit locations, association map to relevant POs, SS/Coreset association, etc.

A new DCI format with new DCI size can increase the blind decoding complexity for idle mode, where in the idle mode, as opposed to an active or connected mode, the WD is not receiving or sending data (other than control signaling). However, a new DCI format with a new DCI size can allow for improved performance, in case the payload size can be made much more compact than that of DCI 1-0. For instance, if there are only 12 groups of WDs 22 that needs to be addressed, the PWUS DCI payload can be 12+24-bit cyclic redundancy check (CRC)=36 bits. If indeed, there is a need to size-match the new DCI format to 1-0, then the network node 16 can explicitly configure the number of padding bits used when the DCI format is used for PWUS. In this way, the WD 22 can take advantage of the explicit padding as preexisting information in cases where it is feasible. For example, if the WD 22 is only monitoring PWUS in a monitoring occasion, the WD 22 can use the preexisting information about zero-padding to improve detection performance. Otherwise, the WD 22 can decode the full payload and use only the relevant parts appropriately.

In addition to the DCI format, the PWUS DCI may be associated with a specific RNTI. The RNTI can be the P-RNTI itself, particularly if the DCI format 1-0 is employed, or a function of P-RNTI. Alternatively, multiple RNTIs can be used for different PWUSs associated with different POs. Other existing RNTIs can also be used. For example, ps-RNTI can be used for DCI format 2-6, or the WD 22 can be configured with a specific paging power saving RNTI, for example, pps-RNTI. As another example, each PWUS may be associated with a different RNTI. Then, when the associated WD 22 receives the PWUS (potentially with a 0 bit payload) with a specific RNTI, the WD 22 may conclude that the WD 22 can expect a paging message in the associated PO.

An explicit RNTI can be configured for use with a PWUS associated with one or more paging occasions. For instance, if there are 128 POs configured in a cell, at most 128 RNTIs can be configured. A many-to-one mapping can be designed to reduce the number of RNTIs for PWUS.

A group of RNTIs can be configured for use with PWUS for the cell, and a pre-determined mapping can be specified to associate one or more paging occasion(s) and an RNTI from that group of RNTIs. This allows the network node 16 to control different POs with PWUS with different RNTIs.

The SS/Coreset associated with PWUS may be the same as that associated with paging PDCCH, especially if PWUS is embedded in paging DCI. Alternatively, a separate SS may be used. In one embodiment, a narrower CORESET may be used to allow the WD 22 to perform PWUS monitoring with a more power-efficient receiver configuration. In another embodiment, the PWUS SS may be tailored to define the PWUS monitoring occasions or monitoring window.

PWUS Offset, Range and Mobile Originated (MO) Configuration

In one embodiment, the PWUS offset is defined as the offset to a specific PO or a paging frame, e.g., X ms before the PO, or before a specific PO within the group of POs that the PWUS is associated with, which could be the first PO in that group. Instead of milliseconds (ms), other time units, such as slots or frames can be used.

In one approach, the PWUS offset determines the location of the PWUS occasion, while in an alternative approach, the PWUS offset determines the start of the location after which the WD 22 may expect the PWUS, i.e., the start of the PWUS monitoring window. For example, the PWUS offset may additionally determine an end point of the monitoring window, or include a PWUS range (i.e., a time range) within which the WD 22 can monitor PWUS DCI. For example, the WD 22 may monitor PWUS DCI from X ms to Y ms before a specific PO, or a specific PO within a group of POs.

Furthermore, PWUS offset and/or range can be configured explicitly, e.g., by higher layer signaling such as SI, or implicitly, e.g., by a specific SS association. In another approach to implicit configuration, e.g., when PWUS is part of a preceding PO, the offset and/or range are implicitly configured as part of one or more preceding POs. The search space type for PWUS can be explicitly configured by higher layers to be one of Type 2 CSS or Type 3 CSS. Different types of search spaces may lead to different characteristics such as a WD's ability to receive the corresponding information. The search space ID for PWUS can be the same or different from the search space ID used for paging reception.

With regard to the PWUS monitoring opportunity (MO) when the WD 22 can monitor PWUS DCI, in one approach, a specific SS associated with a Coreset (e.g., Coreset 0 or another Coreset), can be used to indicate the PWUS MOs. Alternatively, the WD 22 may be configured with multiple PWUS MOs, i.e., one or more SSs associated with a Coreset, or alternatively, one SS associated with a Coreset. However, including an SS duration parameter of more than 1, i.e., the same SS being repeated in one or more of the upcoming slots, depending on the value configured for the SS duration parameter, may occur. In this case and other similar examples, when the WD 22 is configured with a specific paging configuration, it means that the WD 22 receives a specific configuration for paging from higher layer signaling, such as SI or dedicated signaling as part of PCCH-config broadcasted through a SI. As such, the WD 22 is informed of the configuration in terms of a number of paging frames (PFs), number of POs per PF, or in this case, the PWUS MO, etc. Therefore, the WD 22 knows, for example, in which occasions to monitor paging, or the PWUS. In this specific example, the WD 22 receives a configuration related to PWUS MO which is one or more specific SSs, and as such, the WD 22 can monitor PWUS in such occasions according to the configured SSs.

Additionally, for the WD 22 to identify the PWUS MOs, the WD 22 may only consider the PWUS MOs after PWUS offset until a specific end point, and/or a PWUS range as the valid PWUS MOs. The end point can also be determined as up until a PO or paging failure (PF) or until a specified offset before a PO/PF, or until an end of a DRX cycle, or an SSB, or system frame number (SFN), etc. In some embodiments, a PWUS indicates a PO to be monitored or not monitored based on a frequency of paging. For example, in some embodiments, when the frequency of paging in a PO is above a first threshold, then the PO is monitored, whereas when the frequency of paging in PO is lower than a second threshold, then the PO is not monitored.

Further, in cases where a specific SS falls within the valid range of PWUS MOs, the WD 22 can be further configured (or preconfigured e.g., as part of specifications) if one or more SSs are valid as PWUS MOs. For example, the WD 22 may be configured to only consider the first occasion of a SS within the valid PWUS range as a PWUS MO, and the rest are not considered as PWUS MOs. Alternatively, when the SS duration parameter is more than one, only the first of them is considered as a PWUS MO, in some embodiments.

In another embodiment, the PWUS MO can be configured based on a pre-configured formula, e.g., as part of the specifications. In one example, a function of WD 22 ID (e.g., the same ID which is used by the WD 22 to obtain its PO), can be used to determine a PWUS MO, or a PWUS range within which the WD 22 is expected to monitor PWUS. This is called a PWUS occasion. Further, one or more PWUS MO can be configured as part of the PWUS occasion configuration such that the WD 22 can monitor PWUS in those occasions.

PWUS Association with POs and/or Paging Groups

Another parameter which may be configured for the WD 22, e.g., using higher layer signaling such as SI, is how a PWUS is associated with one or more of the upcoming POs. In one approach, each PWUS is associated with a specific PO.

Alternatively, a group of POs (i.e., more than two POs) maybe associated with a PWUS. Association of the PWUS and POs can be part of the higher layer signaling configuration of PWUS. For example, the NW may configure the PWUS which is associated with 1, . . . ,N POs (e.g., N=10).

In one embodiment, the group of POs can be consecutive POs, or alternatively selected based on a formula, or explicit selection. These POs may be monitored by different WDs 22, i.e., multiple WDs 22 will be monitoring a given PWUS. For example, if two POs are associated with a PWUS, the first and the second PO can in sequence, and the PWUS can be configured before the first PO. As such, the PWUS MO, offset, or range can be configured with respect to the first PO, but the PWUS indication can be associated to both POs.

In another embodiment, the group of POs may be multiple subsequent POs monitored by a certain WD 22, whereby the PWUS signals that the WD 22 should monitor multiple of its coming POs.

In another embodiment, the WD 22 may be associated to one or more specific paging groups. As such, the PWUS may be associated with a paging group in addition to a PO. For example, the WD 22 may monitor PWUS in a specific PWUS MO, and receives an indication by the PWUS that the paging group that it belongs to may be paged in one or more of the upcoming Pos. Then, if the WD 22 belongs to the associated paging group, the WD 22 should wake up in its own PO, expecting that the group that the WD 22 belongs to is paged in this PO.

PWUS DCI Contents and Interpretation

In some cases, the PWUS can be associated with one or more POs and can be received in a specific PWUS MO. with a specific configuration parameter, e.g., a specific SS, a specific RNTI, a specific offset, etc. Further, the DCI payload may be 0 bits, i.e., a DCI size of 0. Thus, when the WD 22 detects the PWUS, the WD 22 may indicate that the WD 22 can expect a paging message in the associated POs or paging groups. Alternatively, the DCI contents and the WD 22 behavior upon detection of PWUS can be configured by the network node 16, e.g., through higher layer signaling.

In another alternative, e.g., when the PWUS is related to multiple POs, the payload can contain a bitfield indicating which paging occasions will contain a paging message, and the network node 16 configuration can include information about the bitfield and the corresponding association between the bitfield and the paging occasions, e.g., bit-x corresponding to the information about paging messages sent in PO-y. There can be additional bits in the payload of the PWUS to further indicate the group for which the paging message is intended. For example, if there are 4 paging occasions associated with a PWUS MO, then the network node 16 can configure a bitfield of length four in the PWUS DCI and use four bits in the PWUS DCI to indicate which of the four paging occasions contain a paging message. The network node 16 can additionally configure 2 bits per PO to indicate any grouping information—for example bit0 may indicate a WD 22 with odd identification number (WDID) (or within a first group) having a paging message in the PO, and bit1 indicates whether a WD 22 with even WDID (or within a second group) has a paging message in the PO. Alternatively, within the PWUS payload, each PO and/or paging group and indication bit may be included, where the indication bit can indicate if the WD 22 should monitor its PO (e.g., if the indication bit is “1”) or when the WD 22 could skip monitoring its PO.

In one embodiment, the indication is a wake-up indication—if the PWUS is detected (or in another example, the PWUS and the corresponding bit associated with the WDID or the group ID associated with the WDID is detected), the WD 22 should monitor its upcoming PO. If the WD 22 chooses to rely on PWUS indications for PO monitoring, the WUS reception quality may be sufficiently robust, since a missed WUS will lead to a missed paging reception (leading to paging escalation or re-attempt of paging). This solution may also be selected when most POs are empty (e.g., no pages). WUS configuration/transmission parameters, e.g., resource allocation and modulation and coding scheme (MCS) selection, is then optimized to minimize the missed detection probability.

To reduce the risk of missed paging and/or reduce network node resource consumption associated with WUS transmission, the network node 16 can configure the WUS as a go-to-sleep indication. When the WUS is detected, the WD 22 need not monitor its upcoming PO. This solution may also be selected when most POs are occupied. PWUS configuration is then optimized to minimize the false alarm probability.

The network node 16 can explicitly configure the functionality and interpretation of the bit in the bitfield in a PWUS DCI. The functionality can be indicated via system information signaling associated with the paging and/or paging WUS indication. The functionality can indicate a wake-up command, or a go-to-sleep command with a configured action that the WD 22 follows in the absence of detection of the PWUS DCI in PWUS MO(s). This functionality can be configured separately based on different paging occasions, or based on different WD 22 types (e.g. wake-up for normal WDs 22, and go-to-sleep for RedCap WDs 22, etc.).

For functionality that indicates a wake-up command, when the WD 22 detects a PWUS DCI in PWUS MO(s) and the corresponding bit associated with the WD 22 (e.g., WD ID or WD group ID, etc.) indicates a first value, the WD 22 may then monitor the associated paging occasion. When the WD 22 detects a PWUS DCI in PWUS MO(s) and the corresponding bit associated with the WD 22 indicates a second value, the WD 22 can skip monitoring the associated paging occasion. When the WD 22 does not detect a PWUS DCI in PWUS MO(s), the WD 22 can skip monitoring the associated paging occasion.

For functionality that indicates a go-to-sleep command, when the WD 22 detects a PWUS DCI in PWUS MO(s) and the corresponding bit associated with the WD 22 indicates a first value, the WD 22 monitors the associated paging occasion. When the WD 22 detects a PWUS DCI in PWUS MO(s) and the corresponding bit associated with the WD 22 indicates a second value, the WD 22 can skip monitoring the associated paging occasion. When the WD 22 does not detect a PWUS DCI in PWUS MO(s), the WD 22 monitors the associated paging occasion.

A benefit of the go-to-sleep command is that the network node 16 can opportunistically allow the WD 22 to save power without increased network node power consumption. This is so because the network node 16 can potentially bundle the PWUS for one or a group of WDs 22 into reserved bits of a paging DCI intended for another WD 22. The interpretation of the indicator can be configured by the network node 16 as part of the PWUS configuration through higher layer signaling, such as SI or radio resource control (RRC) signaling. Alternatively, the interpretation of the indicator can be pre-defined in the standard.

In cases where the paging WUS is DCI based, additional commands, such as the T/F resource allocation of paging PDSCH can also be included in the same DCI, e.g., if DCI format 1-0 is employed and PWUS is multiplexed in the same DCI as the paging DCI. In this case, the DCI size, payload and its content including configuration of specific bitfields for specific operations can be done through higher layer signaling. Alternatively, if PWUS is only considered as a WUS, then additional bits, e.g., T/F allocation, transport block (TB) scaling, and MCS, may be considered as reserved, and omitted. In the same way, the PWUS may also be multiplexed in the same DCI which includes a short message, or in the sDCI which includes both a short message as well as a paging message.

In the alternative, where the PWUS indicates multiple POs for a WD 22, the DCI payload may indicate the number of such subsequent POs (DRX cycles) to monitor.

The PWUS DCI may also provide additional paging on the PDCCH or the physical downlink shared channel (PDSCH) configuration information where the formats can be adopted dynamically on a per-PO basis. In one class of embodiments, the PWUS may carry PDCCH and/or PDSCH configuration constraints that may be stricter than the configuration provided in the SI, for example, cross-slot transmission, a narrower PDCCH bandwidth BW than the CORESET or narrower PDSCH bandwidth than the default maximum. This may mean fewer BD candidates, etc. The WD 22 can then operate the PDCCH/PDSCH receiver in a more efficient configuration. If the WD 22 does not monitor the PWUS, it can still receive the paging signaling using the default assumptions based on the current configuration. In another class of embodiments, the WD 22 may be mandated to monitor the PWUS and obtain PDCCH SS, format, or other configuration information that may differ from the current default configuration.

PWUS Configuration Information Provision

The network node 16 may configure the parameters described herein through higher layer signaling, e.g., SI. When the parameters are to be configured through SI, the can be configured as part of the PCCH-config. Furthermore, the configuration can be cell-specific, or WD specific.

In one class of embodiments, WUS configuration may be provided in SI (e.g., remaining minimum system information (RMSI), other system information (OSI), and/or system information block (SIBn)). Configuration information may include DCI format, DCI size, offset, SS; T/F location, etc.

In one embodiment, the WD behavior upon detection of a PWUS can be part of the configuration. In some embodiments, the network node 16 may signal WUS indication=“wake up” if paging is infrequent (low PO occupancy) and WUS indication=“sleep on” if a large fraction of POs are occupied and/or when maximal paging robustness is desired. PWUS interpretation can be further configured by the NW based on its load. For example, when the load is low, PWUS can be configured to be interpreted as to monitor PO, but if the load is high, PWUS is only used to indicate skipping a PO, otherwise, the WD 22 should monitor its PO.

In another embodiment, the WD behavior upon not detecting the PWUS is either pre-configured, e.g., as part of specifications, or configured explicitly by the network node 16. For example, when the WD 22 does not detect PWUS in any of PWUS MOs, then the WD 22 should monitor its PO.

PWUS activation indication may be explicit, via an indicator bit in the SI, or implicit through presence or absence of configuration information in SI. The network node 16 may provide a SI change indication when the PWUS presence status changes. In a related embodiment, activating PWUS is not accompanied by an SI change indication and the WD 22 can check the SI contents to utilize the PWUS function, but the deactivation is accompanied by an SI change. The deactivation can also be based on L1 indications e.g., the current paging DCI can activate/deactivate PWUS.

In another class of embodiments, the PWUS may be provided only to WDs 22 that last connected in the camping cell. Configuration information may be provided via dedicated RRC while the WD 22 is in connected mode.

In another example, the PWUS configuration is part of the RRC release message.

In another example, the PWUS is only valid for a specific amount of time, determined by a validity timer. The validity timer can be in units of slots, POs or milliseconds, for example. The network node 16 may further configure the WD 22 with specific indications to extend or stop the validity timer. For example, reception of PWUS may extend the validity timer, or an indication, e.g., a paging DCI can stop the timer.

In one embodiment, the network (NW) may further provide a link quality limit for PWUS reception. Camping WDs 22 whose link quality exceeds the threshold may be allowed to rely on WUS, while other WDs 22 may monitor the PDCCH in their POs.

Selection of PWUS Signaling Mode or Configuration

In one class of embodiments, multiple PWUS signaling is supported. In some embodiments, network node 16 may use approaches where not only configuration parameters are adaptable, but so also a WUS mode is adaptable. The network node 16 can thus use an adaptive PWUS strategy. If the paging load is low, a separate PWUS PDCCH may be sent, e.g., close to the nearest SSB. At high load, e.g., >50% POs occupied, the PWUS may be embedded in other POs. The PWUS configuration information in the SI indicates which mode is currently in effect. An SI update message may be sent when the mode is changed.

An adaptive selection may also be applied to determine PWUS DCI formats. For example, the network load may also be used to choose from different DCI formats, or configurations. For example, when the load is high, the PWUS can be multiplexed with other paging DCIs but when the load is low, the PWUS can be in a dedicated DCI with only WUS contents.

According to one aspect, a network node 16 is configured to communicate with a wireless device, WD 22. The network node 16 includes processing circuitry 68 configured to configure a paging wake up signal, PWUS, the PWUS being associated with a radio network temporary identifier, RNTI, and including an indication of at least one paging occasion, PO, to be one of monitored and not monitored by the WD 22. The network node 16 also includes a radio interface 62 in communication with the processing circuitry and configured to transmit the PWUS to the WD 22.

According to this aspect, in some embodiments, the RNTI to which the PWUS is associated depends on a format of downlink control information, DCI, configured to carry the PWUS transmitted by the radio interface. In some embodiments, the RNTI to which the PWUS is associated is a P-RNTI when the DCI format is 1-0. In some embodiments, the PWUS is configured to wake up the WD 22 from one of an idle mode and an inactive mode. In some embodiments, the processing circuitry 68 is further configured to configure the WD 22 to monitor the PWUS according to a selected one of a plurality of search space configurations. In some embodiments, the PWUS is associated with a plurality of POs. In some embodiments, each of the at least one PO is selected to be one of monitored and not monitored based on a formula. In some embodiments, the PWUS is included in a downlink control information, DCI, message on a physical downlink control channel, PDCCH. In some embodiments, the DCI message includes PO usage information. In some embodiments, a DCI message size of zero indicates that an upcoming PO is to be one of monitored and not monitored. In some embodiments, whether the DCI message size of zero indicates that the upcoming PO is to be one of monitored and not monitored is pre-configured by the network node 16. In some embodiments, the processing circuitry 68 is further configured to multiplex the DCI message with other DCI messages based on a network load. In some embodiments, the PWUS further indicates which of a plurality of upcoming POs have a paging message. In some embodiments, the PWUS is configured by the network node 16 to indicate a PO to be one of monitored and not monitored based on a frequency of paging. In some embodiments, the PWUS is configured to be valid for a finite duration of time.

According to another aspect, a method in a network node 16 configured to communicate with a wireless device, WD 22, is provided. The method includes configuring a paging wake up signal, PWUS, the PWUS being associated with a radio network temporary identifier, RNTI, and including an indication of at least one paging occasion, PO, to be one of monitored and not monitored by the WD 22. The method also includes transmitting the PWUS to the WD 22.

According to this aspect, in some embodiments, the RNTI to which the PWUS is associated depends on a format of downlink control information, DCI, configured to carry the PWUS transmitted by the radio interface. In some embodiments, the RNTI to which the PWUS is associated is a P-RNTI when the DCI format is 1-0. In some embodiments, the PWUS is configured to wake up the WD 22 from one of an idle mode and an inactive mode. In some embodiments, the method also includes configuring the WD 22 to monitor the PWUS according to a selected one of a plurality of search space configurations. In some embodiments, the PWUS is associated with a plurality of POs. In some embodiments, each of the at least one PO is selected to be one of monitored and not monitored based on a formula. In some embodiments, the PWUS is included in a downlink control information, DCI, message on a physical downlink control channel, PDCCH. In some embodiments, the DCI message include PO usage information. In some embodiments, a DCI message size of zero indicates that an upcoming PO is to be one of monitored and not monitored. In some embodiments, whether the DCI message size of zero indicates that the upcoming PO is to be one of monitored and not monitored is configured by the network node 16. In some embodiments, the processing circuitry is further configured to multiplex the DCI message with other DCI messages based on a network load. In some embodiments, the PWUS further indicates which of a plurality of upcoming POs have a paging message. In some embodiments, the PWUS is configured by the network node 16 to indicate a PO to be one of monitored and not monitored based on a frequency of paging. In some embodiments, the PWUS is configured to be valid for a finite duration of time.

According to yet another aspect, a WD 22 configured to communicate with a network node 16 is provided. The WD 22 includes a radio interface 82 configured to receive a paging wake up signal, PWUS, associated with a radio network temporary identifier, RNTI, the PWUS including an indication of at least one paging occasion, PO, to be one of monitored and not monitored. The WD 22 also includes processing circuitry 84 in communication with the radio interface and configured to one of monitor and not monitor at least one of the at least one PO as indicated by the PWUS.

According to this aspect, in some embodiments, the RNTI to which the PWUS is associated depends on a format of downlink control information, DCI, configured to carry the PWUS. In some embodiments, the RNTI to which the PWUS is associated is a P-RNTI. In some embodiments, the RNTI to which the PWUS is associated is a ps-RNTI. In some embodiments, the RNTI to which the PWUS is associated is a paging power saving RNTI. In some embodiments, the PWUS is configured to wake up the WD 22 from one of an idle mode and an inactive mode. In some embodiments, the processing circuitry 84 is further configured to monitor a PWUS according to a selected one of a plurality of search space configurations.

According to another aspect, a method in a WD 22 configured to communicate with a network node 16 is provided. The method includes receiving a paging wake up signal, PWUS, associated with a radio network temporary identifier, RNTI, the PWUS including an indication of at least one paging occasion, PO, to be one of monitored and not monitored. The method also includes one of monitoring and not monitoring at least one of the at least one PO as indicated by the PWUS.

According to this aspect, in some embodiments, the RNTI to which the PWUS is associated depends on a format of downlink control information, DCI, configured to carry the PWUS. In some embodiments, the RNTI to which the PWUS is associated is a P-RNTI. In some embodiments, the RNTI to which the PWUS is associated is a ps-RNTI. In some embodiments, the RNTI to which the PWUS is associated is a paging power saving RNTI. In some embodiments, the PWUS is configured to wake up the WD 22 from one of an idle mode and an inactive mode. In some embodiments, the method also includes monitoring a PWUS according to a selected one of a plurality of search space configurations.

According to one aspect, a network node 16 is configured to communicate with a wireless device (WD) 22. The network node 16 includes a radio interface and/or comprising processing circuitry configured to configure the WD 22 to be responsive to a paging wake up signal, PWUS, and configure a PWUS, associated with a specific radio network temporary identifier (RNTI).

According to this aspect, in some embodiments, the PWUS is configured to provide notice to the WD 22 of upcoming paging opportunities, POs. In some embodiments, the PWUS is configured to indicate an offset to at least one paging opportunity, PO. In some embodiments, the PWUS is configured to skip or monitor an underlying paging opportunity. In some embodiments, comprising transmitting the PWUS in a downlink control information, DCI, signal.

According to another aspect, a method implemented in a network node 16 includes configuring the WD 22 to be responsive to a paging wake up signal, PWUS, and configuring a PWUS, associated with a specific radio network temporary identifier (RNTI).

According to this aspect, in some embodiments, the PWUS is configured to provide notice to the WD 22 of upcoming paging opportunities, POs. In some embodiments, the PWUS is configured to indicate an offset to at least one paging opportunity, PO. In some embodiments, the PWUS is configured to skip or monitor an underlying paging opportunity. In some embodiments, the method further includes transmitting the PWUS in a downlink control information, DCI, signal.

According to yet another embodiment, a WD 22 is configured to communicate with a network node 16. The WD 22 includes a radio interface and/or processing circuitry configured to wake up upon receiving a paging wake up signal, PWUS, and monitor for a paging message when an indication in the received PWUS indicates an upcoming paging opportunity, PO.

According to this aspect, in some embodiments, the WD 22 is configured to enter a deep sleep when no paging message is received within a period of time. In some embodiments, the WD 22 is configured to interpret the indication by inspecting a down link control information, DCI, message associated with a particular radio network temporary identifier (RNTI).

According to another aspect, a method implemented in a wireless device (WD) 22, includes waking up upon receiving a paging wake up signal, PWUS, and monitoring for a paging message when an indication in the received PWUS indicates an upcoming paging opportunity, PO.

According to this aspect, in some embodiments, the WD 22 is configured to enter a deep sleep when no paging message is received within a period of time. In some embodiments, the WD 22 is configured to interpret the indication by inspecting a down link control information, DCI, message associated with a particular radio network temporary identifier, RNTI.

Some embodiments include one or more of the following:

Embodiment A1. A network node configured to communicate with a wireless device (WD), the network node configured to, and/or comprising a radio interface and/or comprising processing circuitry configured to:
configure the WD to be responsive to a paging wake up signal, PWUS; and
configure a PWUS, associated with a specific radio network temporary identifier (RNTI).

Embodiment A2. The network node of Embodiment A1, wherein the PWUS is configured to provide notice to the WD of upcoming paging opportunities, POs.

Embodiment A3. The network node of any of Embodiments A1 and A2, wherein the PWUS is configured to indicate an offset to at least one paging opportunity, PO.

Embodiment A4. The network node of any of Embodiments A1-A3, wherein the PWUS is configured to skip or monitor an underlying paging opportunity.

Embodiment A5. The network node of any of Embodiments A1-A4, wherein the network node and/or the processing circuitry and/or the radio interface are further configured to transmit the PWUS in a downlink control information, DCI, signal.

Embodiment B1. A method implemented in a network node, the method comprising:
configuring the WD to be responsive to a paging wake up signal, PWUS; and
configuring a PWUS, associated with a specific radio network temporary identifier (RNTI).

Embodiment B2. The method of Embodiment B1, wherein the PWUS is configured to provide notice to the WD of upcoming paging opportunities, POs.

Embodiment B3. The method of any of Embodiments B1 and B2, wherein the PWUS is configured to indicate an offset to at least one paging opportunity, PO.

Embodiment B4. The method of any of Embodiments B 1-B3, wherein the PWUS is configured to skip or monitor an underlying paging opportunity.

Embodiment B5. The method of any of Embodiments B 1-B4, further comprising transmitting the PWUS in a downlink control information, DCI, signal.

Embodiment C1. A wireless device (WD) configured to communicate with a network node, the WD configured to, and/or comprising a radio interface and/or processing circuitry configured to:
wake up upon receiving a paging wake up signal, PWUS; and
monitor for a paging message when an indication in the received PWUS indicates an upcoming paging opportunity, PO.

Embodiment C2. The WD of Embodiment C1, wherein the WD and/or the processing circuitry and/or the radio interface is configured to enter a deep sleep when no paging message is received within a period of time.

Embodiment C3. The WD of any of Embodiments C1 and C2, wherein the WD and/or the processing circuitry and/or the radio interface is configured to interpret the indication by inspecting a down link control information, DCI, message associated with a particular radio network temporary identifier (RNTI).

Embodiment D1. A method implemented in a wireless device (WD), the method comprising:
waking up upon receiving a paging wake up signal, PWUS; and
monitoring for a paging message when an indication in the received PWUS indicates an upcoming paging opportunity, PO.

Embodiment D2. The method of Embodiment D1, wherein the WD is configured to enter a deep sleep when no paging message is received within a period of time.

Embodiment D3. The method of any of Embodiments C1 and C2, wherein the WD is configured to interpret the indication by inspecting a down link control information, DCI, message associated with a particular radio network temporary identifier, RNTI.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A network node configured to communicate with a wireless device, WD, the network node comprising:
processing circuitry configured to configure a paging wake up signal, PWUS, the PWUS being associated with a radio network temporary identifier, RNTI, and including an indication of at least one paging occasion, PO, to be one of monitored and not monitored by the WD;
a radio interface in communication with the processing circuitry and configured to transmit the PWUS to the WD; and
the RNTI to which the PWUS is associated is a paging power saving RNTI and depends on a format of downlink control information, DCI, configured to carry the PWUS transmitted by the radio interface.

2.-5. (canceled)

6. The network node of claim 1, wherein the PWUS is configured to wake up the WD from one of an idle mode and an inactive mode.

7. The network node of claim 1, wherein the processing circuitry is further configured to configure the WD to monitor the PWUS according to a selected one of a plurality of search space configurations.

8. The network node of claim 1, wherein the PWUS is associated with a plurality of POs.

9. (canceled)

10. The network node of claim 1, wherein the PWUS is included in a downlink control information, DCI, message on a physical downlink control channel, PDCCH.

11.-14. (canceled)

15. The network node of claim 1, wherein the PWUS further indicates which of a plurality of upcoming POs have a paging message.

16. The network node of claim 1, wherein the PWUS is configured by the network node to indicate a PO to be one of monitored and not monitored based on a frequency of paging.

17. (canceled)

18. A method in a network node configured to communicate with a wireless device, WD, the method comprising:
configuring a paging wake up signal, PWUS, the PWUS being associated with a radio network temporary identifier, RNTI, and including an indication of at least one paging occasion, PO, to be one of monitored and not monitored by the WD;
transmitting the PWUS to the WD; and
the RNTI to which the PWUS is associated is a paging power saving RNTI and depends on a format of downlink control information, DCI, configured to carry the PWUS.

19.-22. (canceled)

23. The method of claim 18, wherein the PWUS is configured to wake up the WD from one of an idle mode and an inactive mode.

24. The method of claim 18, further comprising configuring the WD to monitor the PWUS according to a selected one of a plurality of search space configurations.

25. The method of claim 18, wherein the PWUS is associated with a plurality of POs.

26. (canceled)

27. The method of claim 18, wherein the PWUS is included in a downlink control information, DCI, message on a physical downlink control channel, PDCCH.

28.-31. (canceled)

32. The method of claim 18, wherein the PWUS further indicates which of a plurality of upcoming POs have a paging message.

33. The method of claim 18, wherein the PWUS is configured by the network node to indicate a PO to be one of monitored and not monitored based on a frequency of paging.

34. (canceled)

35. A wireless device, WD, configured to communicate with a network node, the WD comprising:
a radio interface configured to receive a paging wake up signal, PWUS, associated with a radio network temporary identifier, RNTI, the PWUS including an indication of at least one paging occasion, PO, to be one of monitored and not monitored;
processing circuitry in communication with the radio interface and configured to one of monitor and not monitor at least one of the at least one PO as indicated by the PWUS; and
the RNTI to which the PWUS is associated is a paging power saving RNTI and depends on a format of downlink control information, DCI, configured to carry the PWUS.

36.-39. (canceled)

40. The WD of claim 35, wherein the PWUS is configured to wake up the WD from one of an idle mode and an inactive mode.

41. The WD of claim 35, wherein the processing circuitry is further configured to monitor a PWUS according to a selected one of a plurality of search space configurations.

42. A method in a wireless device, WD, configured to communicate with a network node, the method comprising:
receiving a paging wake up signal, PWUS, associated with a radio network temporary identifier, RNTI, the PWUS including an indication of at least one paging occasion, PO, to be one of monitored and not monitored;
one of monitoring and not monitoring at least one of the at least one PO as indicated by the PWUS; and
the RNTI to which the PWUS is associated is a paging power saving RNTI and depends on a format of downlink control information, DCI, configured to carry the PWUS.

43.-46. (canceled)

47. The method of claim 42, wherein the PWUS is configured to wake up the WD from one of an idle mode and an inactive mode.

48. The method of claim 42, further comprising monitoring a PWUS according to a selected one of a plurality of search space configurations.
